(19) United States
(12) Patent Application Publication
(10) Pub. No.: US 2018/0253488 A1
(43) Pub. Date: Sep. 6, 2018

(54) PERSONAL CONNECTION INFORMATION CREATING DEVICE, COMPUTER READABLE RECORDING MEDIUM HAVING A PERSONAL CONNECTION INFORMATION CREATION PROGRAM STORED THEREIN, AND A PERSONAL CONNECTION INFORMATION CREATING METHOD

(71) Applicant: Konica Minolta, Inc., Tokyo (JP)

(72) Inventor: Tetsuya Oka, Tokyo (JP)

(73) Assignee: Konica Minolta, Inc., Tokyo (JP)

(21) Appl. No.: 15/904,632

(22) Filed: Feb. 26, 2018

(30) Foreign Application Priority Data
Mar. 1, 2017 (JP) 2017-038663

(51) Int. Cl. G06F 17/30; G06Q 50/00; H04L 29/08

(52) U.S. Cl. CPC G06F 17/30699; H04L 67/306; G06Q 50/01

(57) ABSTRACT

A first information source has a plurality of pieces of first information, having a plurality of items, stored therein. The plurality of items of each piece of the first information is compared with a plurality of items of a piece of second information one by one. If there is an exactly matched item, such item is counted as a first value; and there is a partially matched item, such item is counted as a second value smaller than the first value. A person indicated by the first information having the largest total sum of the count is identified as the person indicated in the second information source.

### CROSS REFERENCE TO RELATED APPLICATIONS

The entire disclosure of Japanese Patent Application No. 2017-038663, filed on Mar. 1, 2017, is incorporated herein by reference in its entirety.

### BACKGROUND

### Technical Field

The present invention relates to a personal connection information creating device, a personal connection information creating program and a personal connection information creating method; and more particularly, to a personal connection information creating device adapted to create personal connection information between persons based on data of a meeting minutes or the like, a computer readable recording medium having a personal connection information creating program stored therein, and a personal connection information creating method.

### Description of the Related Art

Conventionally, there is known a system or the like to create personal connection information between persons based on data of a meeting minutes or the like.

For example, Japanese Unexamined Patent Application Publication No. 2011-108042 describes a personal connection search device for searching a personal connection route to an intended human resource by using a plurality of pieces of meeting minutes information. In such a device, a personal connection information extracting section extracts personal connection related information from electronic documents of a plurality of pieces of meeting minutes data (each having content of a meeting recorded therein) stored in a document DB, wherein the information related to personal connection is information which shows that the participants of the meeting have connection with each other.

### SUMMARY

However, in the personal connection search device described in the aforesaid patent document, if the meeting minutes data only includes a portion of a participant's name (e.g., if the meeting minutes data only includes the family name of a participant), it will not be possible to identify the person with such name. Thus, in such a case, it will not be possible to extract the personal connection related information.

One or more embodiments of the present invention provide a personal connection information creating device capable of identifying a person and creating personal connection information between persons, even if information indicating the person is only partially provided, as well as a computer readable recording medium having a personal connection information creating program stored therein, and a personal connection information creating method.

According to one or more embodiments of the present invention, a personal connection information creating device comprises a first information source that stores a plurality of pieces of first information each having a plurality of items including a personal name, and a personal connection information creator that creates personal connection information between persons based on a second information source, wherein the personal connection information creator includes an extractor that extracts second information from the second information source, the second information having a plurality of items including a personal name, and a person identifier that compares the plurality of items of each of the plurality of pieces of first information stored in the first information source with the plurality of items of the second information item by item, counts an exactly matched item, if any, as a first value and a partially matched item, if any, as a second value smaller than the first value, and identifies a person indicated in the first information having the maximum total sum of the count as the person in the second information source, and wherein the personal connection information creator creates personal connection information related to the person identified by the person identifier.

According to one or more embodiments of the present invention, a non-transitory recording medium has a computer readable personal connection information creating program stored therein, wherein the personal connection information creating program causes a personal connection information creating device to operate, wherein the personal connection information creating device comprises a first information source that stores a plurality of pieces of first information each having a plurality of items including a personal name, and a personal connection information creator that creates personal connection information between persons based on a second information source, wherein the personal connection information creating program causes the personal connection information creating device to perform: extraction processing for extracting second information from the second information source, the second information having a plurality of items including a personal name; person identifying processing for comparing the plurality of items of each of the plurality of pieces of first information stored in the first information source with the plurality of items of the second information item by item, counting an exactly matched item, if any, as a first value and a partially matched item, if any, as a second value smaller than the first value, and identifying a person indicated in the first information having the maximum total sum of the count as the person in the second information source; and personal connection information creating processing for creating personal connection information related to the identified person.

According to one or more embodiments of the present invention, a personal connection information creating method in a personal connection information creating system has a first information source that stores a plurality of pieces of first information, each having a plurality of items including a personal name, and a personal connection information creator that creates personal connection information between persons based on a second information source, the method comprising: an extraction step of extracting second information from the second information source, the second information having a plurality of items including a personal name; a person identifying step of comparing the plurality of items of each of the plurality of pieces of first information stored in the first information source with the plurality of items of the second information item by item, counting an exactly matched item, if any, as a first value and a partially matched item, if any, as a second value smaller than the first value, and identifying a person indicated in the first information having the maximum total sum of the count as the person in the second information source; and a personal connection information creating step of creating personal connection information related to the identified person.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing an example of the configuration of a personal connection information creating system according to one or more embodiments of the present invention;

FIG. 2 is a block diagram showing an example of the configuration of a user terminal according to one or more embodiments of the present invention;

FIG. 3 is a block diagram showing an example of the configuration of a personal connection information creating server according to one or more embodiments of the present invention;

FIG. 4 is a view showing an example of a data table of a person information database according to one or more embodiments of the present invention;

FIG. 5 is a block diagram showing an example of the function of a control section of the personal connection information creating server according to one or more embodiments of the present invention;

FIG. 6 is a view showing an example of data of a meeting minutes transmitted to the personal connection information creating server according to one or more embodiments of the present invention;

FIG. 7 is a view (part 1) showing an example of a data table in a personal connection information database according to one or more embodiments of the present invention;

FIG. 8 is a view (part 1) showing an example of a personal connection chart according to one or more embodiments of the present invention;

FIG. 9 is a view (part 1) showing an example of a personal connection chart according to one or more embodiments of the present invention, in a case where a keyword is displayed;

FIG. 10 is a flowchart showing personal connection information creating processing according to one or more embodiments of the present invention;

FIG. 11 is a view showing an example of data of a contract transmitted to the personal connection information creating server according to one or more embodiments of the present invention;

FIG. 12 is a view (part 2) showing an example of a data table in a personal connection information database according to one or more embodiments of the present invention;

FIG. 13 is a view showing an example of data of an E-mail transmitted to the personal connection information creating server according to one or more embodiments of the present invention;

FIG. 14 is a view showing another example of data of the meeting minutes transmitted to the personal connection information creating server according to one or more embodiments of the present invention;

FIG. 15 is a view (part 3) showing an example of a data table in a personal connection information database according to one or more embodiments of the present invention;

FIG. 16 is a view (part 2) showing an example of a personal connection chart according to one or more embodiments of the present invention;

FIG. 17 is a view (part 2) showing an example of a personal connection chart according to one or more embodiments of the present invention, in a case where a keyword is displayed; and

FIG. 18 is a view showing another example of the configuration of the personal connection information creating system according to one or more embodiments of the present invention.

### DETAILED DESCRIPTION OF EMBODIMENTS

Hereinafter, embodiments of the present invention will be described with reference to the drawings. However, the scope of the invention is not limited to the disclosed embodiments.

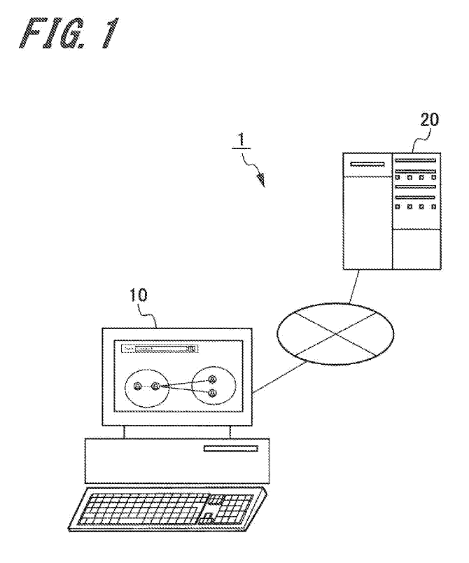

A personal connection information creating program, a personal connection information creating device and a personal connection information creating method according to one or more embodiments of the present invention will be described below with reference to FIG. 1 to FIG. 18.

[Personal Connection Information Creating System]

FIG. 1 is a view showing an example of the configuration of a personal connection information creating system.

As shown in FIG. 1, a personal connection information creating system 1 includes a user terminal 10 and a personal connection information creating server (a personal connection information creating device) 20, where the user terminal 10 and the personal connection information creating server 20 can be connected to each other through a communication network. Incidentally, Ethernet (registered trademark) or the like can be used as the standard of the communication network. Each device will be described below.

[User Terminal]

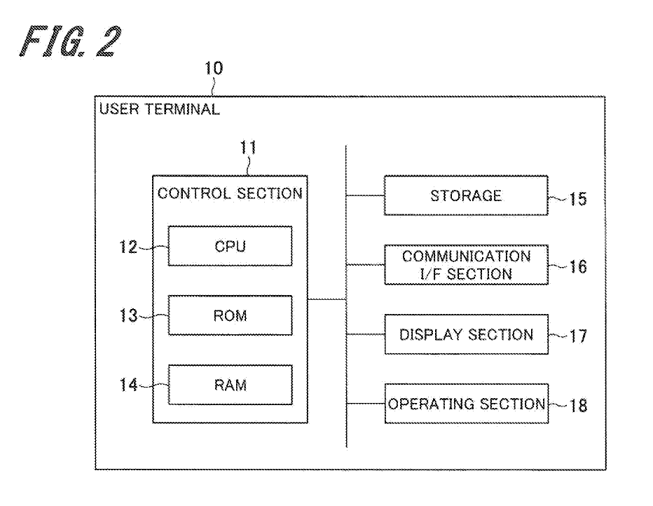

FIG. 2 is a block diagram showing an example of the configuration of the user terminal.

The user terminal 10 is a computer device, such as a personal computer or the like, and is adapted to transmit the data (i.e., a second information source) of a meeting minutes or the like to the personal connection information creating server 20, and graphically display a personal connection chart created by the personal connection information creating server 20. The user terminal 10 includes a control section 11, a storage 15, a communication I/F section 16, a display section 17, an operating section 18 and the like.

The control section 11 includes a CPU (Central Processing Unit) 12 and various memories, such as a ROM (Read Only Memory) 13, a RAM (Random Access Memory) 14 and the like; wherein the CPU 12 develops and executes a control program stored in the ROM 13 or the storage 15 in the RAM 14 to thereby control the operation of the entire user terminal 10. For example, a document creating application is executed by the control section 11 (the CPU 12).

The storage 15 is composed of a HDD (Hard Disk Drive), a SSD (Solid State Drive) or the like, and is adapted to store the program for the CPU 12 to control each section, information associated with processing functions of the user terminal 10, and data created by the document creating application.

The communication I/F section 16 includes a NIC (Network Interface Card), a modem and the like, and is adapted to connect the user terminal 10 to the communication network; and thereby the data of the meeting minutes or the like is transmitted from the user terminal 10 to the personal connection information creating server 20, and the personal connection chart is received from the personal connection information creating server 20.

The display section 17 is composed of a LCD (Liquid Crystal Display), an EL (electroluminescence) display or the like, and is adapted to display a document creating screen of the document creating application and the personal connection chart received from the personal connection information creating server 20.

The operating section 18 includes a mouse a keyboard and the like, and can be operated to create a manuscript using the document creating application, and issue various instructions and requirements to the personal connection information creating server 20.

[Personal Connection Information Creating Server]

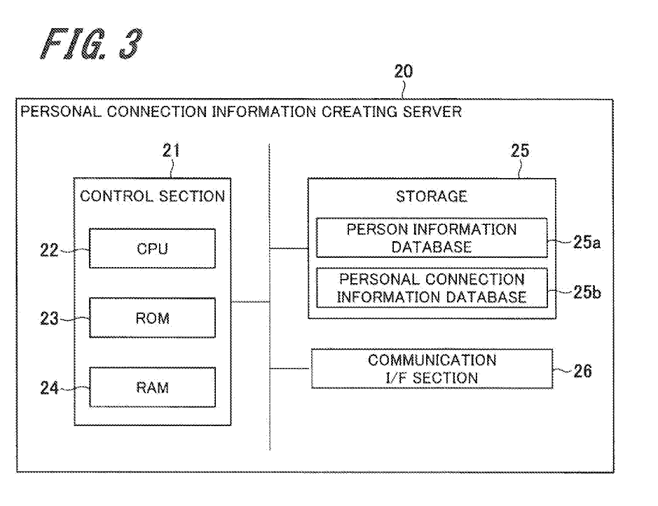

FIG. 3 is a block diagram showing an example of the configuration of the personal connection information creating server.

The personal connection information creating server 20 is a computer device adapted to create and register personal connection information based on the data of the meeting minutes or the like transmitted from the user terminal 10, and provide personal connection information or a personal connection chart to the user terminal 10 according to the requirement from the user terminal 10. The personal connection information creating server 20 includes a control section 21, a storage 25 and a communication I/F section 26. The personal connection information creating server 20 may further include a display section, an operating section and the like, according to necessity.

The control section 21 includes a CPU 22 and various memories, such as a ROM 23, a RAM 24 and the like; wherein the CPU 22 develops and executes a control program stored in the ROM 23 or the storage 25 in the RAM 24 to thereby control the operation of the entire personal connection information creating server 20.

The storage 25 is composed of a HDD, a SSD or the like, and is adapted to store a program for the CPU 22 to control each section. Further, the storage 25 includes a person information database (i.e., a first information source, or a person information storage) 25a for storing a plurality of pieces of person information (i.e., first information), and a database (not shown) for storing data received from the user terminal 10. The storage 25 further includes a personal connection information database (i.e., a personal connection information storage) 25b for storing personal connection information created by the control section 21.

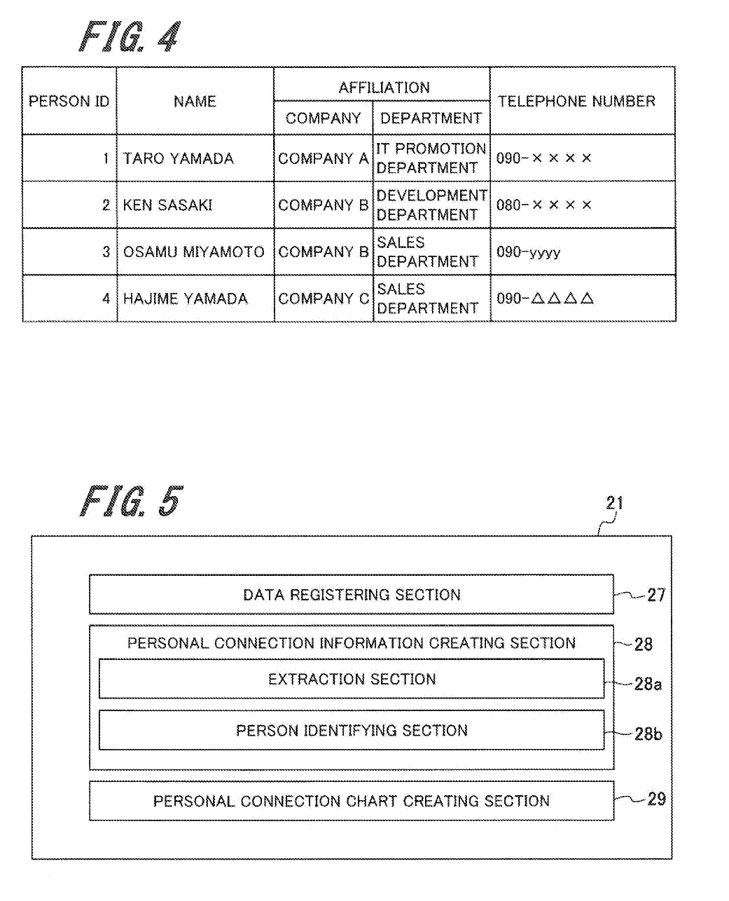

FIG. 4 is a view showing an example of a data table of the person information database.

The person information database 25a of the storage 25 has a data table in which a plurality of pieces of person information are stored. The person information includes a “person ID” (which is a number unique to each piece of person information) and various items (information) as those typically printed on a business card, such as “name” (a personal name), “affiliation”, “telephone number” and the like. For example, the person information of a person ID “1” includes “Taro Yamada” as the “name”, “IT Promotion Department, Company A” as the “affiliation”, and “090-xxxx” as the “telephone number”.

The communication I/F section 26 includes a NIC, a modem and the like, and is adapted to connect the personal connection information creating server 20 to the communication network so as to receive the data of the meeting minutes or the like from the user terminal 10 and transmit the personal connection information or the personal connection chart to the user terminal 10.

FIG. 5 is a block diagram showing an example of the function of the control section of the personal connection information creating server 20.

The control section 21 also functions as a data registering section 27, a personal connection information creating section 28 and a personal connection chart creating section 29. The data registering section 27 registers the data of the meeting minutes or the like received from the user terminal 10 in the databases of the storage 25.

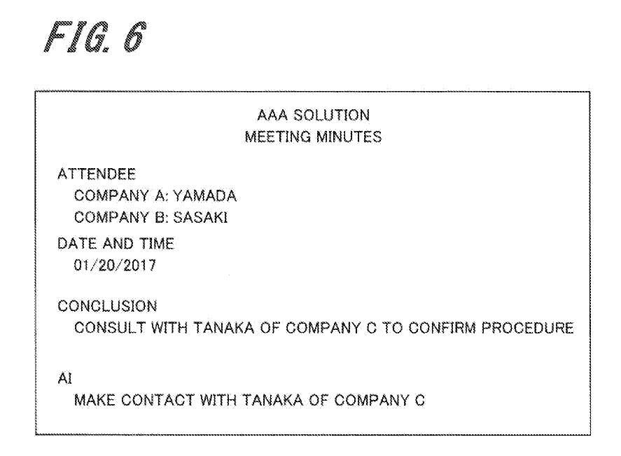

FIG. 6 is a view showing an example of the data of the meeting minutes transmitted to the personal connection information creating server 20.

In one or more embodiments, the data transmitted from the user terminal 10 to the personal connection information creating server 20 includes the data of the meeting minutes as shown in FIG. 6 for example. The data of the meeting minutes is created by the document creating application of the user terminal 10, and includes text data of various items. Examples of the various items include “name of meeting”, “attendee”, “date and time”, “conclusion” and “action item” (also referred to as “AI” hereinafter). The data of the meeting minutes shown in FIG. 6 includes text data of the following items: “AAA Solution” as the “name of meeting”; “Yamada, Company A” and “Sasaki, Company B” as the “attendee”; “01/20/2017” as the “date and time”; “Consult with Tanaka of Company C to confirm the procedure” as the “conclusion”; and “Make contact with Tanaka of Company C” as the “AI”. Incidentally, the data transmitted from the user terminal 10 to the personal connection information creating server 20 is not limited to the data of a meeting minutes, but may also be data of a contract or an E-mail, or image data about content of the meeting minutes, the contract or the E-mail.

When the data registering section 27 registers the data received from the user terminal 10 in the database, the personal connection information creating section 28 creates the personal connection information based on such data. Here, the personal connection information in one or more embodiments means information about personal connection between persons. To be more specific, the personal connection information means information about communication between/among persons registered in the data table of the person information database 25a, and includes the person IDs registered in the person information database 25a and various items extracted from the received data.

As shown in FIG. 5, the personal connection information creating section 28 has an extraction section 28a adapted to extract various information (including a personal name) from the received data. Further, the personal connection information creating section 28 includes a person identifying section 28b which is adapted to determine whether or not the person indicated by the name extracted from the received data is the person indicated in the person information in the person information database 25a or the person identified by the person ID included in the personal connection information in the personal connection information database 25b.

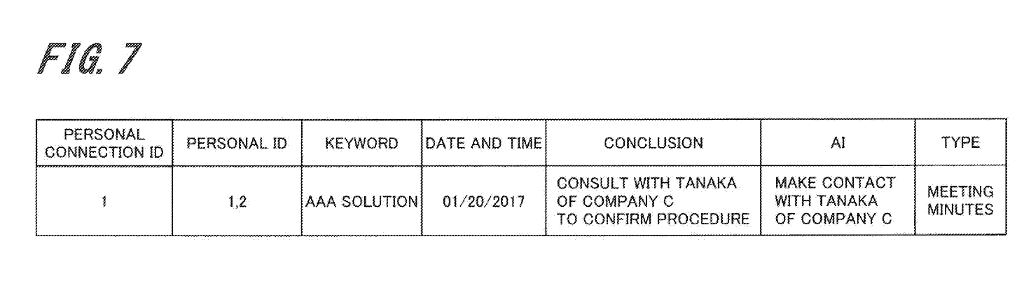

FIG. 7 is a view (part 1) showing an example of the data table in the personal connection information database.

The personal connection information creating section 28 registers the created personal connection information in the data table (see FIG. 7) of the personal connection information database 25b of the storage 25. As shown in FIG. 7, the personal connection information includes an item “personal connection ID” and an item “person ID”, wherein the item “personal connection ID” is a number unique to each piece of personal connection information, and the item “person ID” is in common with the person ID of the person information database 25a. Further, the personal connection information includes an item “keyword” extracted from the received data. As described later, from the data received by the personal connection information creating server 20, the name of the meeting, the name of the contract and the subject of the E-mail are extracted as the “keyword”. Further, the personal connection information includes the following items: “date and time” (which is information about date and time); “conclusion”; “AI”; and “type” (which shows the type of the received data). The personal connection information with “personal connection ID” of “1” shown in FIG. 7 includes the following items: “1, 2” as the “person ID”; “AAA Solution” as the “keyword”; “01/20/2017” as the “date and time”; “Consult with Tanaka of Company C to confirm the procedure” as the “conclusion”; “Make contact with Tanaka of Company C” as the “AI”; and “Meeting minutes” as the “type”. The details about the personal connection information creating processing (i.e., the processing for the personal connection information creating section 28 to create the personal connection information) will be described later.

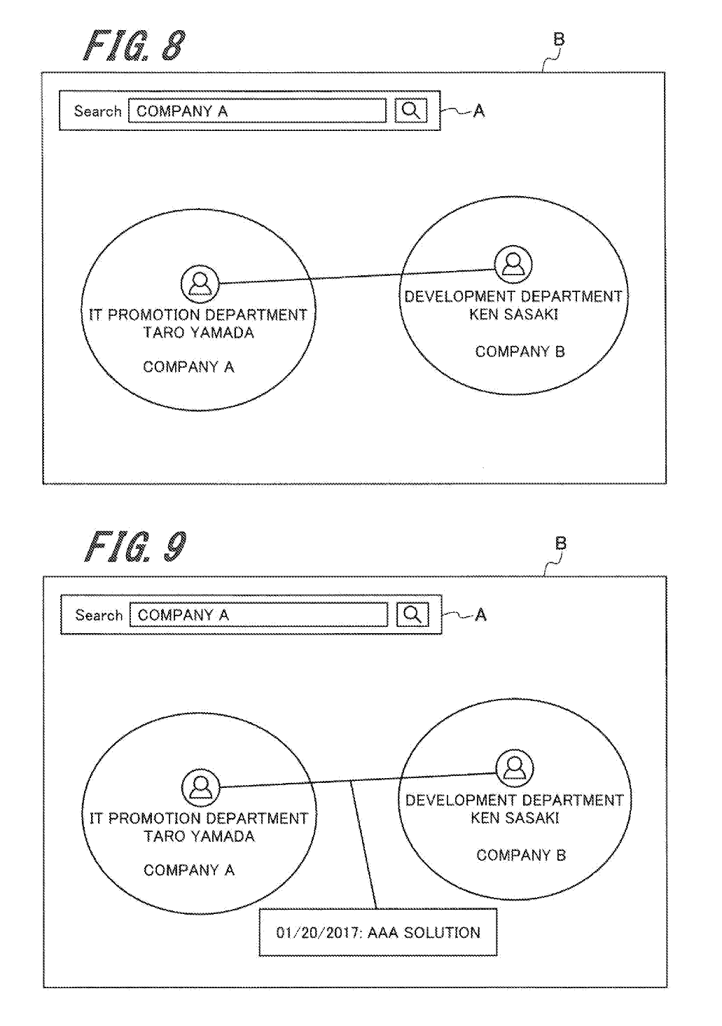

FIG. 8 and FIG. 9 are each a view (part 1) showing an example of the personal connection chart.

In response to the instruction from the user terminal 10, the personal connection chart creating section 29 creates a personal connection chart based on the personal connection information registered in the personal connection information database 25b. Further, the personal connection chart creating section 29 provides the created personal connection chart to the user terminal 10. In one or more embodiments, the personal connection chart is a chart in which the personal connection information is graphically expressed. FIG. 8 shows a personal connection chart created based on the personal connection information with the personal connection ID of “1” registered in the data table of the personal connection information database 25b shown in FIG. 7.

When creating a personal connection chart, the personal connection chart creating section 29 first provides the user terminal 10 with a personal connection information providing screen B in which a search word inputting box A capable of inputting an arbitrary search word is arranged. When a search word is inputted from the user terminal 10, the personal connection chart creating section 29 refers to the person information database 25a and the personal connection information database 25b to identify the personal connection information corresponding to the inputted search word. Further, the personal connection chart creating section 29 creates a personal connection chart based on the identified personal connection information.

For example, in a case where there are the data table of the person information database 25a shown in FIG. 4 and the data table of the personal connection information database 25b shown in FIG. 7, and where “Company A” is inputted as the search word, the personal connection chart creating section 29 will first refer to the person information database 25a to identify the person information that includes the search word. Thus, in the aforesaid case, the personal connection chart creating section 29 identifies the person information with the person ID of “1” that includes “Company A” as the item (information) of the affiliation.

Next, the personal connection chart creating section 29 will refer to the personal connection information database 25b to identify the personal connection information that includes the person ID of the identified person information. In the aforesaid case, the personal connection chart creating section 29 identifies the personal connection information with the personal connection ID of “1” as the personal connection information that includes the person ID “1”. Further, the personal connection chart creating section 29 creates the personal connection chart shown in FIG. 8 based on the identified personal connection information.

When creating the personal connection chart, the personal connection chart creating section 29 assigns a portrait-like icon to each of the person IDs included in the identified personal connection information, displays the icons at a predetermined interval, and connects each two portrait-like icons with a line. Further, the personal connection chart creating section 29 refers to the person information database 25a to identify the person information based on the person ID included in the identified personal connection information, to thereby identify the name and affiliation of the person. In the aforesaid case, with regard to the person ID “1”, “Taro Yamada” and “IT Promotion Department, Company A” in the person information of the person ID “1” are identified as the name and affiliation of the person. Further, with regard to the person ID “2”, “Ken Sasaki” and “Development Department, Company B” in the person information of the person ID “2” are identified as the name and affiliation of the person. Further, the personal connection chart creating section 29 surrounds the icon(s) of the identified person(s) in a circle for each company affiliation, and displays the name and affiliation (department affiliation) under the icon(s).

If the operating section 18 of the user terminal 10 is operated to put the pointer on the line connecting the portrait-like icons, the items included in the personal connection information (such as the keyword and the date and time) will be displayed in a pop-up window as shown in FIG. 9. Incidentally, FIG. 9 shows an example in which the keyword and the date and time are displayed; however, other items included in the personal connection information such as conclusion and AI and the like may also be displayed in addition to the keyword and the date and time. In other words, the items of the personal connection information to be displayed can be suitably selected.

[Personal Connection Information Creating Processing]

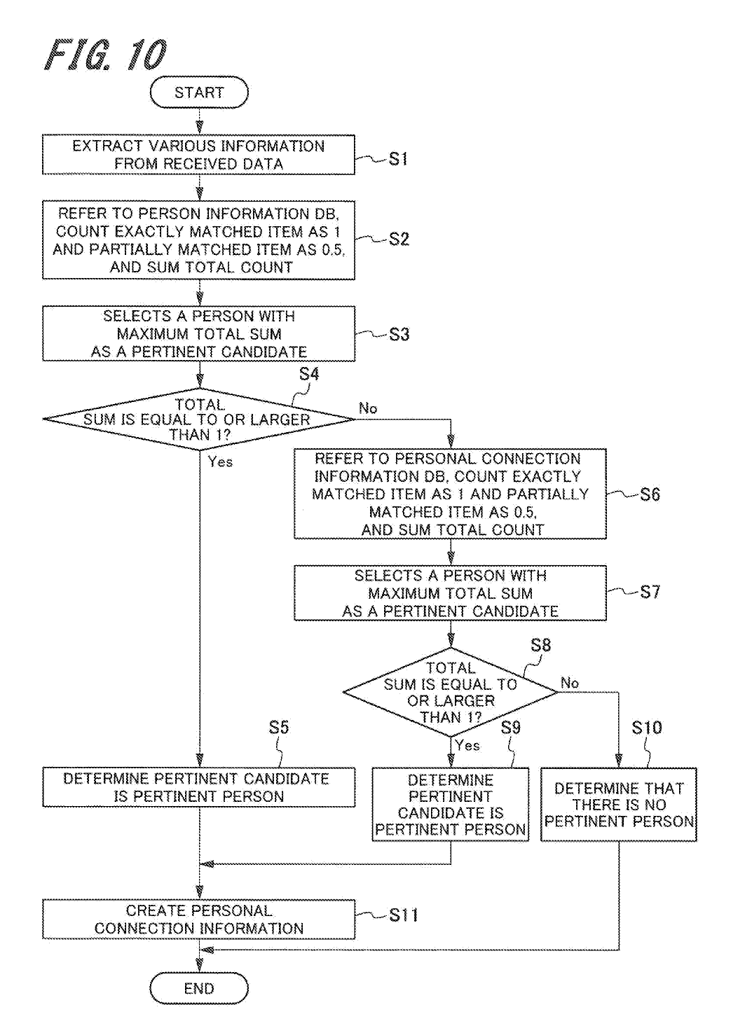

The personal connection information creating processing executed by the personal connection information creating section 28 of the control section 21 of the personal connection information creating server 20 will be described below with reference to FIG. 10.

FIG. 10 is a flowchart showing the personal connection information creating processing.

Upon receiving the data from the user terminal 10, the personal connection information creating section 28 starts the personal connection information creating processing. First, the extraction section 28a of the personal connection information creating section 28 extracts various information (the second information) from the received data (step S1). To be specific, the extraction section 28a extracts the name and affiliation (as information associated with the person) from the received data based on an information extracting method such as existing natural language processing. Further, the extraction section 28a extracts each item of the personal connection information shown in FIG. 7 (i.e., the “keyword”, the “date and time”, the “conclusion” and the “AI” in FIG. 7). Incidentally, if the received data is image data, OCR (Optical Character Recognition) processing will be performed on the image data to thereby convert the image data into text data, and then the name and affiliation and each item of the personal connection information will be extracted from the converted text data.

Next, the person identifying section 28b of the personal connection information creating section 28 refers to the person information database 25a, and compares the items of each piece of person information with the extracted information (items) one by one to thereby count the value of the matched items. As a result of the comparison, if there is an exactly matched item, the person identifying section 28b will count such item as “1”; and if there is a partially matched item, the person identifying section 28b will count such item as “0.5”. In one or more embodiments, the name of the person information is compared with the extracted name, and the affiliation of the person information is compared with the extracted affiliation. Further, the total sum of the count is calculated for each piece of person information (step S2).

Next, the person identifying section 28b of the personal connection information creating section 28 selects a person identified by the person information having the maximum total sum calculated in Step S2 as a pertinent candidate of the person indicated by the information extracted from the received data (step S3). Next, the personal connection information creating section 28 determines whether or not the total sum of the person information related to the person selected as the pertinent candidate is equal to or larger than 1 (step S4).

If it is determined in step S4 that the total sum of the person information to be determined is equal to or larger than 1 (i.e., if it is determined “YES” in step S4), the person identifying section 28b of the personal connection information creating section 28 will determine that the person selected as the pertinent candidate is the pertinent person as indicated in the information extracted from the received data (step S5). In other words, the person identifying section 28b of the personal connection information creating section 28 identifies the person indicated in the received data as the person indicated in the person information of the person information database 25a.

Next, the personal connection information creating section 28 executes the processing of step S11 (which will be described later).

On the other hand, if it is determined in step S4 that the total sum of the person information to be determined is less than 1 (i.e., if it is determined “NO” in step S4), the person identifying section 28b of the personal connection information creating section 28 will perform the processing of step S6. In the processing of step S6, the person identifying section 28b refers to the personal connection information database 25b and the person information database 25a, and compares the items of each piece of personal connection information with the items (information) extracted in step S1 one by one. If there is an exactly matched item, the person identifying section 28b will count such item as “1”; and if there is a partially matched item, the person identifying section 28b will count such item as “0.5”. In one or more embodiments, the person identifying section 28b compares the name identified by the person ID of the personal connection information with the extracted name, and compares the keyword of the personal connection information with the extracted keyword. Further, the total sum is calculated for each piece of personal connection information (step S6).

Next, the person identifying section 28b of the personal connection information creating section 28 selects a person identified by the person ID included in the personal connection information having the maximum total sum calculated in Step S6 as a pertinent candidate of the person indicated in the received data (step S7). Next, the person identifying section 28b determines whether or not the total sum of the personal connection information related to the pertinent candidate selected in step S7 is equal to or larger than 1 (step S8).

If it is determined in step S8 that the total sum of the personal connection information to be determined is equal to or larger than 1 (i.e., if it is determined “YES” in step S8), the person identifying section 28b of the personal connection information creating section 28 will determine that the person identified by the person ID included in the identified personal connection information is the pertinent person as described in the received data (step S9). In other words, the person identifying section 28b of the personal connection information creating section 28 identifies the person indicated in the received data as the person identified by the person ID included in the personal connection information.

Next, the personal connection information creating section 28 executes the processing of step S11 (which will be described later).

On the other hand, if it is determined in step S8 that the total sum of the personal connection information to be determined is less than 1(i.e., if it is determined “NO” in step S8), the person identifying section 28b of the personal connection information creating section 28 will perform the processing of step S10. In the processing of step S10, the person identifying section 28b determines that there is no pertinent person as the person indicated in the information extracted from the received data (step S10). Thereafter, the personal connection information creating section 28 terminates the personal connection information creating processing.

In step S11, the personal connection information creating section 28 creates a piece of personal connection information, and registers the created personal connection information in the personal connection information database 25b (step S11), wherein the created personal connection information includes various items (such as keyword and the like) extracted in step S1 and the person ID of the person having been determined as the pertinent person in step S5 or step S9. At this time, the personal connection information creating section 28 assigns a personal connection ID, which is a unique number, to the created personal connection information. Further, information corresponding to the type (e.g., the meeting minutes, the contract and the E-mail) of the received data is added to the personal connection information. Incidentally, the type of the received data is discriminated from the text data in the data based on an information extracting method such as existing natural language processing. Thereafter, the personal connection information creating section 28 terminates the personal connection information creating processing.

A concrete example of the personal connection information creating processing performed by the personal connection information creating server 20 when having received the data of the meeting minutes shown in FIG. 6 will be described below with reference to FIG. 10. First, the extraction section 28a of the personal connection information creating section 28 executes the processing of step S1. To be specific, the personal connection information creating section 28 extracts “Yamada, Company A” and “Sasaki, Company B” as the name and affiliation from the received data based on an information extracting method such as existing natural language processing. Further, the personal connection information creating section 28 extracts various other items which are: “AAA Solution” as the “keyword”; “01/20/2017” as the “date and time”; “Consult with Tanaka of Company C to confirm the procedure” as the “conclusion”; and “Make contact with Tanaka of Company C” as the “AI”.

Next, the person identifying section 28b of the personal connection information creating section 28 executes the processing of step S2. To be specific, the person identifying section 28b compares the name of each piece of person information with the extracted name “Yamada”; if the both exactly match each other, the item “name” of the person information will be counted as “1”; and if the both partially match each other, the item “name” of the person information will be counted as “0.5”. In one or more embodiments, the extracted name “Yamada” partially matches the name “Taro Yamada” of the person information of the person ID “1” shown in FIG. 4 (only the part of the family name matches each other). Thus, “Taro Yamada” of the person information of the person ID “1” is counted as “0.5”. Further, the extracted name “Yamada” partially matches the name “Hajime Yamada” of the person information of the person ID “4” (only the part of the family name matches each other). Thus, “Hajime Yamada” of the person information of the person ID “4” is counted as “0.5”.

Further, the person identifying section 28b compares the affiliation of each piece of person information with the extracted affiliation “Company A”; if the both exactly match each other, the item “affiliation” of the person information will be counted as “1”; and if the both partially match each other, the item “affiliation” of the person information will be counted as “0.5”. In one or more embodiments, the extracted affiliation “Company A” partially matches the affiliation “IT Promotion Department, Company A” of the person information of person ID “1” (only the part of company matches each other). Thus, “IT Promotion Department, Company A” of the person information of the person ID “1” is counted as “0.5”.

When total sum of the count is calculated for each piece of person information, the person information of the person ID “1” will be “1”, the person information of the person ID “4” will be “0.5”, and the person information of other person IDs will be “0”.

Next, in step S3, the person identifying section 28b of the personal connection information creating section 28 selects the person indicated in the person information of the person ID “1” having the maximum total sum calculated in Step S2 as a pertinent candidate. Next, in step S4, the person identifying section 28b determines whether or not the total sum of the person information related to the person selected as the pertinent candidate is equal to or larger than 1. In the aforesaid case, since the total sum of the person information of the person ID “1” is “1”, the person identifying section 28b moves the processing to step S5. Further, the person identifying section 28b determines that the person “Taro Yamada” (which is indicated by the person information of the person ID “1”) selected as the pertinent candidate is the pertinent person. In other words, the person indicated by the extracted information “Yamada, Company A” is identified as the person “Taro Yamada” indicated in the person information of the person ID “1”.

Further, the processing of steps S2 to S5 is also performed for “Sasaki, Company B” extracted from the data received in step S1. In such case, since the extracted name “Sasaki” partially matches the name “Ken Sasaki” of the person information of the person ID “2”, “Ken Sasaki” of the person information of the person ID “2” is counted as “0.5”. Further, since the extracted affiliation “Company B” partially matches the affiliation “IT Promotion Department, Company B” of the person information of the person ID “2” (only the part of company matches each other), “IT Promotion Department, Company B” of the person information of the person ID “2” is counted as “0.5”. As a result, the person “Ken Sasaki” indicated in the person information of the person ID “2” is determined as the pertinent person. In other words, the person indicated by the extracted information “Sasaki, Company B” is identified as the person “Ken Sasaki” indicated in the person information of the person ID “2”.

Further, in step S11, the personal connection information creating section 28 creates a piece of personal connection information, wherein the created personal connection information includes the keyword and the like extracted in step S1, and the person ID “1” of “Taro Yamada” and the person ID “2” of “Ken Sasaki”, which had been each determined is the pertinent person in step S5. Thereafter, the personal connection information creating section 28 adds a personal connection ID (e.g., “1”), which is a unique number, and information of the type “meeting minutes” to the created personal connection information, and then registers the personal connection information in the personal connection information database 25b (see FIG. 7).

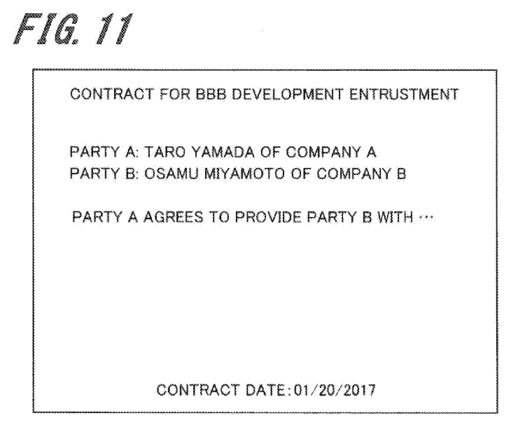

Next, the personal connection information creating processing performed by the personal connection information creating server 20 when having received the data of the contract as shown in FIG. 11 will be described below with reference to FIG. 10 and FIGS. 11 to 13.

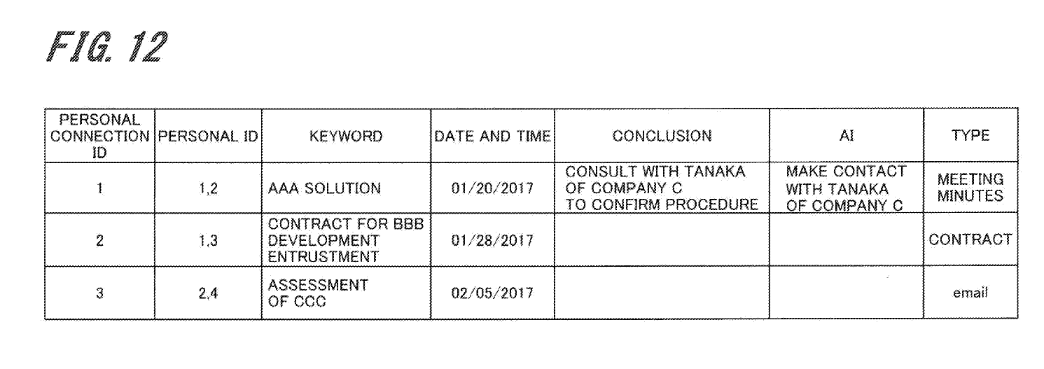

FIG. 11 is a view showing an example of the data of the contract transmitted to the personal connection information creating server. FIG. 12 is a view (part 2) showing an example of the data table in the personal connection information database.

As shown in FIG. 11, “Contract for BBB Development Entrustment” is described in the contract as the name of the contract. Further, “Party A: Taro Yamada, Company A” and “Party B: Osamu Miyamoto, Company B” are described in the contract as parties to the contract. Further, “01/28/2017” is described in the contract as contract date. The contents described in the contract also include various terms of the contract, although the description of the details of such terms is omitted in FIG. 11.

When the personal connection information creating server 20 has received the data of the contract shown in FIG. 11, the extraction section 28a of the personal connection information creating section 28 executes the processing of step S1. To be specific, the personal connection information creating section 28 extracts “Taro Yamada, Company A” and “Osamu Miyamoto, Company B” as the name and affiliation from the text data of the received data based on an information extracting method such as existing natural language processing. Further, the personal connection information creating section 28 extracts various items from the received data; to be specific, the personal connection information creating section 28 extracts “Contract for BBB Development Entrustment” as the “keyword” and “01/28/2017” as the “date and time”.

Thereafter, the same processing as performed for receiving the data of the meeting minutes described above is performed to identify the person related to the contract. In the case of the aforesaid contract, with regard to “Taro Yamada, Company A”, the extracted name “Taro Yamada” exactly matches the name “Taro Yamada” of the person information of the person ID “1” as shown in FIG. 4. Thus, “Taro Yamada” of the person information of the person ID “1” is counted as “1”. Further, the extracted affiliation “Company A” partially matches the affiliation “IT Promotion Department, Company A” of the person information of person ID “1” (only the part of company matches each other). Thus, “IT Promotion Department, Company A” of the person information of the person ID “1” is counted as “0.5”. In other words, the total sum of the count related to the person information of the person ID “1” is “1.5”. The total sum “1.5” of the count related to the person information of the person ID “1” is the largest value in the person information of the person IDs 1 to 4. Thus, with regard to “Taro Yamada, Company A”, the person “Taro Yamada” indicated in the person information of the person ID “1” is determined as the pertinent person. In other words, the person indicated by the extracted information “Taro Yamada, Company A” is identified as the person “Taro Yamada” indicated in the person information of the person ID “1”.

Further, with regard to “Osamu Miyamoto, Company B”, the extracted name “Osamu Miyamoto” exactly matches the name “Osamu Miyamoto” of the person information of the person ID “3” as shown in FIG. 4. Thus, “Osamu Miyamoto” of the person information of the person ID “3” is counted as “1”. Further, the extracted affiliation “Company B” partially matches the affiliation “Sales Department, Company B” of the person information of person ID “3” (only the part of company matches each other). Thus, “Sales Department, Company B” of the person information of the person ID “3” is counted as “0.5”. In other words, the total sum of the count related to the person information of the person ID “3” is “1.5”. The total sum “1.5” of the count related to the person information of the person ID “3” is the largest value in the person information of the person IDs 1 to 4. Thus, with regard to “Osamu Miyamoto, Company B”, the person “Osamu Miyamoto” indicated in the person information of the person ID “3” is determined as the pertinent person. In other words, the person indicated by the extracted information “Osamu Miyamoto, Company B” is identified as the person “Osamu Miyamoto” indicated in the person information of the person ID “3”.

With regard to “Taro Yamada, Company A” and “Osamu Miyamoto, Company B”, after having determined the pertinent person, the personal connection information creating section 28 creates a piece of personal connection information, wherein the created personal connection information includes various items (such as the keyword and the like) extracted in step S1, and the person ID “1” of “Taro Yamada” and the person ID “3” of “Osamu Miyamoto”, which had been each determined is the pertinent person. Thereafter, the personal connection information creating section 28 adds a personal connection ID (e.g., “2”), which is a unique number, and information of the type “Contract” to the created personal connection information, and then registers the personal connection information in the personal connection information database 25b (see FIG. 12). Incidentally, as shown in FIG. 12, in the data table of the personal connection database, the item(s) impossible to be extracted from the data of the contract (such as the item “conclusion” and the item “AI”) is (are) blank.

A concrete example of the personal connection information creating processing performed by the personal connection information creating server 20 when having received the data of an E-mail shown in FIG. 13 will be described below with reference to FIG. 10.

FIG. 13 is a view showing an example of the data of the E-mail transmitted to the personal connection information creating server.

As shown in FIG. 13, “Assessment of CCC” is described in the E-mail as the subject. In the E-mail, “Hajime Yamada, Company C” is described as the sender, “Ken Sasaki, Company B” is described as the receiver, and “02/05/2017” is described as the transmission date.

When the personal connection information creating server 20 has received the data of the E-mail shown in FIG. 13, the extraction section 28a of the personal connection information creating section 28 executes the processing of step S1. To be specific, the personal connection information creating section 28 extracts “Hajime Yamada, Company C” and “Ken Sasaki, Company B” as the name and affiliation from the text data of the received data based on an information extracting method such as existing natural language processing. Further, the personal connection information creating section 28 extracts various items from the received data; to be specific, the personal connection information creating section 28 extracts “Assessment of CCC” as “keyword” and “02/05/2017” as “date and time”.

Thereafter, the same processing as performed for receiving the data of the meeting minutes and the contract described above is performed to identify the person related to the contract. In the case of the aforesaid E-mail, with regard to the item “Hajime Yamada, Company C”, the extracted name “Hajime Yamada” exactly matches the name “Hajime Yamada” of the person information of the person ID “4” as shown in FIG. 4. Thus, “Hajime Yamada” of the person information of the person ID “4” is counted as “1”. Further, the extracted affiliation “Company C” partially matches the affiliation “Sales Department, Company C” of the person information of person ID “4” (only the part of company matches each other). Thus, “Sales Department, Company C” of the person information of the person ID “4” is counted as “0.5”. In other words, the total sum of the count related to the person information of the person ID “4” is “1.5”. The total sum “1.5” of the count related to the person information of the person ID “4” is the largest value in the person information of the person IDs 1 to 4. Thus, with regard to “Hajime Yamada, Company C”, the person “Hajime Yamada” indicated in the person information of the person ID “4” is determined as the pertinent person. In other words, the person indicated by the extracted information “Hajime Yamada, Company C” is identified as the person “Hajime Yamada” indicated in the person information of the person ID “4”.

Further, with regard to “Ken Sasaki, Company B”, the extracted name “Ken Sasaki” exactly matches the name “Ken Sasaki” of the person information of the person ID “2” as shown in FIG. 4. Thus, “Ken Sasaki” of the person information of the person ID “2” is counted as “1”. Further, the extracted affiliation “Company B” partially matches the affiliation “Development Department, Company B” of the person information of person ID “2” (only the part of company matches each other). Thus, “Development Department, Company B” of the person information of the person ID “2” is counted as “0.5”. In other words, the total sum of the count related to the person information of the person ID “2” is “1.5”. The total sum “1.5” of the count related to the person information of the person ID “2” is the largest value in the person information of the person IDs 1 to 4. Thus, with regard to “Ken Sasaki, Company B”, the person “Ken Sasaki” indicated in the person information of the person ID “2” is determined as the pertinent person. In other words, the person indicated by the extracted information “Sasaki, Company B” is identified as the person “Ken Sasaki” indicated in the person information of the person ID “2”.

With regard to “Hajime Yamada, Company C” and “Hajime Yamada, Company B”, after having determined the pertinent person, the personal connection information creating section 28 creates a piece of personal connection information, wherein the created personal connection information includes various items (such as the keyword and the like) extracted in step S1, and the person ID “4” of “Hajime Yamada” and the person ID “2” of “Ken Sasaki”, which had been each determined is the pertinent person. Thereafter, the personal connection information creating section 28 adds a personal connection ID (e.g., “3”), which is a unique number, and information of the type “Contract” to the created personal connection information, and then registers the personal connection information in the personal connection information database 25b (see FIG. 12). Incidentally, as shown in FIG. 12, in the data table of the personal connection database, the item(s) impossible to be extracted from the data of the E-mail (such as the item “conclusion” and the item “AI”) is(are) blank.

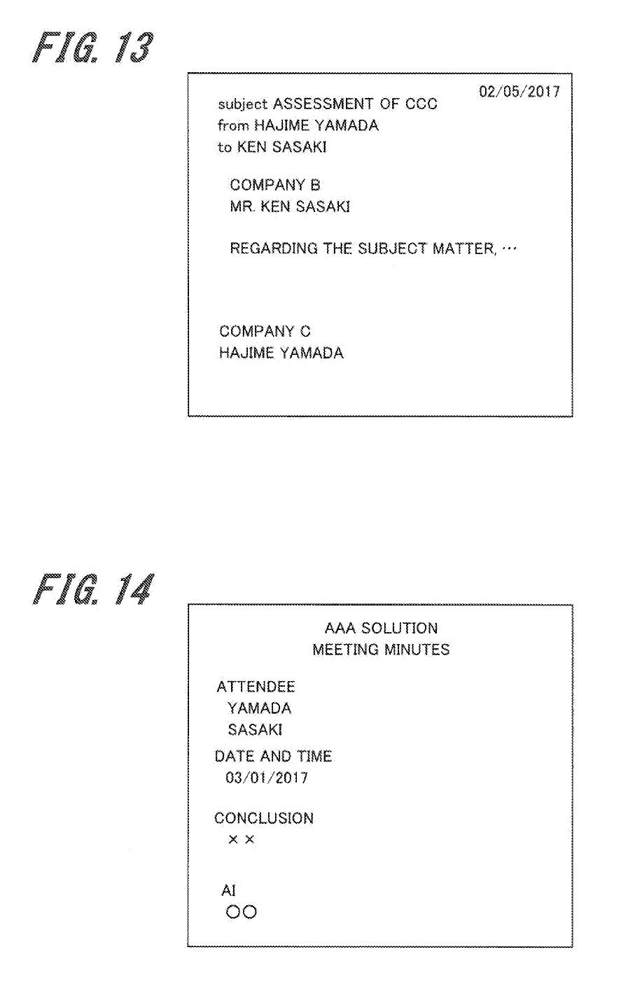

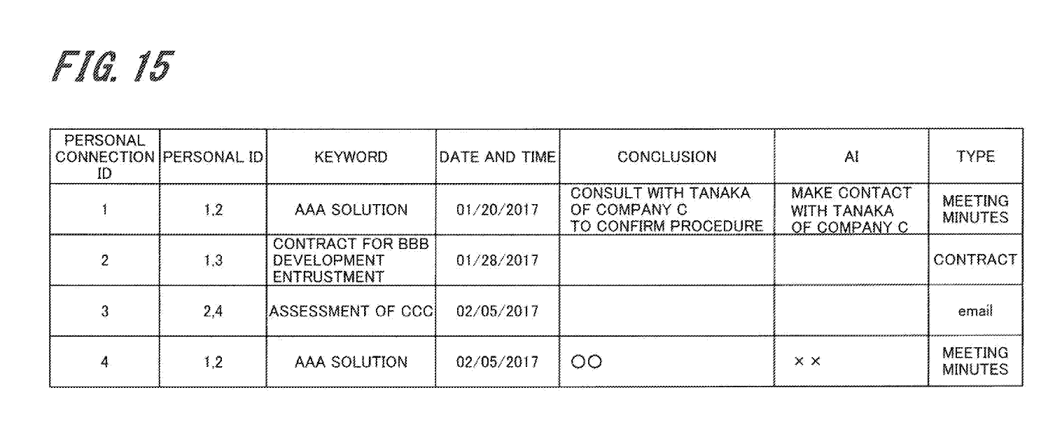

A concrete example of the personal connection information creating processing performed by the personal connection information creating server 20 when having received the data of the meeting minutes shown in FIG. 14 will be described below with reference to FIG. 10, FIG. 14 and FIG. 15, in a case where the data table of the personal connection information database 25b is in a state shown in FIG. 12.

FIG. 14 is a view showing another example of the data of the meeting minutes transmitted to the personal connection information creating server. FIG. 15 is a view (part 3) showing an example of the data table in the personal connection information database.

In the meeting minutes shown in FIG. 14, “AAA Solution” is described as the name of meeting, “Yamada” and “Sasaki” are described as the attendee, “03/01/2017” is described as the date and time, “xx” is described as the conclusion, and “00” is described as the AI. Incidentally, the meeting minutes shown in FIG. 14 is different from the meeting minutes shown in FIG. 6 in that the meeting minutes shown in FIG. 14 has no information about the affiliation of the attendee.

When the personal connection information creating server 20 has received the data of the meeting minutes shown in FIG. 14, the extraction section 28a of the personal connection information creating section 28 executes the processing of step S1. To be specific, the personal connection information creating section 28 extracts “Taro Yamada” and “Sasaki” as the name from the received data based on an information extracting method such as existing natural language processing. Further, the personal connection information creating section 28 extracts various items from the received data; to be specific, the personal connection information creating section 28 extracts “AAA Solution” as the “keyword”, “03/01/2017” as the “date and time”, “xx” as the “conclusion”, and “OO” as the “AI”.

Next, the person identifying section 28b of the personal connection information creating section 28 executes the processing of step S2. To be specific, the name of the person information of the person information database 25a is compared with the extracted “Yamada”. Here, as shown in FIG. 4, since “Yamada” partially matches “Taro Yamada” of the person ID “1” and “Hajime Yamada” of the person ID “4” (i.e., only the part of the family name matches each other), “Taro Yamada” of the person ID “1” and “Hajime Yamada” of the person ID “4” are each counted as “0.5”.

Here, unlike the case where the meeting minutes is received shown in FIG. 6, since no information about the affiliation of the attendee is described in the meeting minutes shown in FIG. 14, the item “affiliation” is not counted for each piece of person information. Thus, when total sum of the count is calculated for each piece of person information, the person information of the person ID “1” will be “0.5”, the person information of the person ID “4” will also be “0.5”, and the person information of other person IDs will be “0”.

Next, in step S3, the person identifying section 28b of the personal connection information creating section 28 selects the persons indicated in the person information of the person IDs “1” and “4” having the maximum total sum calculated in Step S2 as pertinent candidates. Next, in step S4, the person identifying section 28b determines whether or not the total sum of the person information related to the person selected as the pertinent candidate is equal to or larger than 1. In the aforesaid case, since the total sum of the person information of the person IDs “1” and “4” is “0.5”, the person identifying section 28b moves the processing to step S6.

In the processing of step S6, the person identifying section 28b of the personal connection information creating section 28 refers to the personal connection information database 25b and the person information database 25a, and compares the keyword and the name identified by the person ID with the keyword “AAA Solution” and the name “Yamada” and “Sasaki” extracted in step S1 for each piece of personal connection information. If there is an exactly matched item, the person identifying section 28b will count such item as “1”; and if there is a partially matched item, the person identifying section 28b will count such item as “0.5”.

When the data table of the personal connection information database 25b is in a state shown in FIG. 12, since the extracted “Yamada” and “Sasaki” partially match the names “Taro Yamada” and “Ken Sasaki” identified by the person IDs “1, 2” included in the personal connection information of the personal connection ID “1” (i.e., only the part of the family name matches each other), the person IDs “1, 2” of the personal connection information of the personal connection ID “1” are counted as “0.5”.

Further, since “AAA Solution” extracted from the meeting minutes exactly matches the keyword “AAA Solution” of the personal connection information of the personal connection ID “1”, “AAA Solution” of the personal connection information of the personal connection ID “1” is counted as “1”. Thus, the total sum of the count related to the personal connection information of the personal connection ID “1” becomes “1.5”. Similarly, when performing the same count, the total sum of the count related to the personal connection information of the personal connection ID “2” becomes “0”. Further, with regard to the personal connection information of personal connection ID “3”, since the extracted “Yamada” and “Sasaki” partially match the names “Hajime Yamada” (person ID 4) and “Ken Sasaki” (person ID 2) identified by the person IDs “2, 4” included in the personal connection information of the personal connection ID “3” (i.e., only the part of the family name matches each other), the person IDs “2, 4” are counted as “0.5”. Thus, the total sum of the count related to the personal connection information of the personal connection ID “3” becomes “0.5”.

Next, in step S7, the person identifying section 28b of the personal connection information creating section 28 selects a person identified by the person ID included in the personal connection information of the personal connection ID “1” having the maximum total sum calculated in Step S6 as a pertinent candidate. In other words, “Taro Yamada” identified by the person ID “1” and “Ken Sasaki” identified by the person ID “2” are selected as pertinent candidates.

Next, in step S8, the person identifying section 28b of the personal connection information creating section 28 determines whether or not the total sum of the personal connection information related to the pertinent candidate selected in step S7 is equal to or larger than 1. In the aforesaid case, since the total sum of the personal connection information of the personal connection ID “1” is “1.5”, the personal connection information creating section 28 moves the processing to step S9.

Next, in step S9, with regard to “Yamada” extracted from the received data, the person identifying section 28b of the personal connection information creating section 28 determines “Taro Yamada” of the person ID “1” selected as the pertinent candidate is the pertinent person. In other words, the person indicated by “Yamada” extracted from the received data is identified as the person “Taro Yamada” indicated in the person information of the person ID “1”.

Further, with regard to “Sasaki” extracted from the received data, the personal connection information creating section 28 determines “Ken Sasaki” of the person ID “2” selected as the pertinent candidate is the pertinent person. In other words, the person indicated by “Sasaki” extracted from the received data is identified as the person “Ken Sasaki” indicated in the person information of the person ID “2”.

Further, in step S11, the personal connection information creating section 28 creates a piece of personal connection information, wherein the created personal connection information includes various items (such as the keyword and the like) extracted in step S1, and the person ID “1” of “Taro Yamada” and the person ID “2” of “Ken Sasaki”, which had been each determined is the pertinent person in step S9. Thereafter, the personal connection information creating section 28 adds a personal connection ID (e.g., “4”), which is a unique number, and information of the type “meeting minutes” to the created personal connection information, and then registers the personal connection information in the personal connection information database 25b (see FIG. 15).

Next, processing for the personal connection chart creating section 29 to create a personal connection chart will be described below with reference to FIG. 4 and FIGS. 15 to 17, in a case where there are a data table of the person information database 25a shown in FIG. 4 and a data table of the personal connection information database 25b shown in FIG. 15, and where “Company A” is inputted in the search word inputting box.

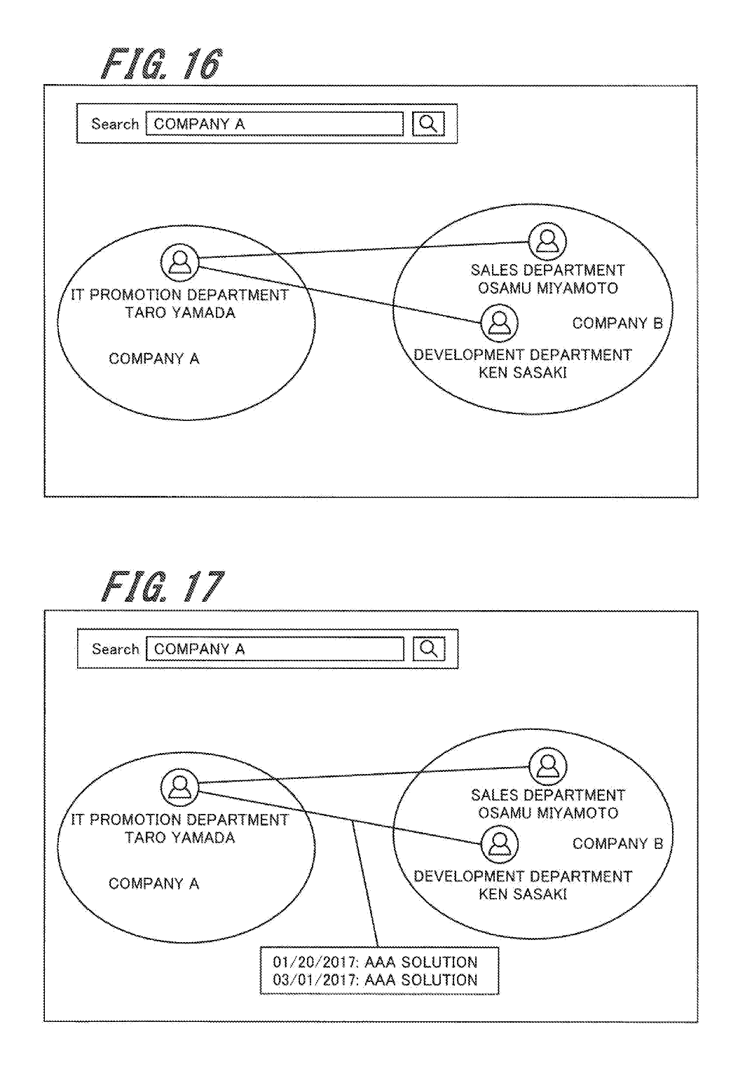

FIG. 16 and FIG. 17 are each a view (part 2) showing an example of the personal connection chart.

First, the personal connection chart creating section 29 refers to the person information database 25a to identify person information that includes the search word. Thus, in the aforesaid case, the person information of the person ID “1”, which includes “Company A” as the affiliation, is identified.

Next, the personal connection chart creating section 29 refers to the personal connection information database 25b to identify a personal connection ID which is the personal connection information including the person ID of the identified person information. In the aforesaid case, the personal connection chart creating section 29 identifies the personal connection information with the personal connection ID “1”, the personal connection information with personal connection ID “2” and the personal connection information with personal connection ID “4”, as the personal connection information including the person ID “1”.

Further, the personal connection chart creating section 29 creates the personal connection chart shown in FIG. 16 based on the identified personal connection information. To be specific, the personal connection chart creating section 29 assigns a portrait-like icon to each of the person IDs included in the identified personal connection information, displays the portrait-like icons at a predetermined interval, and connects each two portrait-like icons with a line.

Further, the personal connection chart creating section 29 refers to the person information database 25a to identify the name and affiliation of the person identified by the person ID included in the personal connection information. In the aforesaid case, “Taro Yamada” and “IT Promotion Department, Company A” are identified as the name and affiliation of the person identified by the person ID “1”. Further, “Ken Sasaki” and “Development Department, Company B” are identified as the name and affiliation of the person identified by the person ID “2”. Further, “Osamu Miyamoto” and “Sales Department, Company B” are identified as the name and affiliation of the person identified by the person ID “3”. Further, the personal connection chart creating section 29 surrounds the identified person(s) in a circle for each company affiliation, and displays the identified name and affiliation (department affiliation) under the icon(s) assigned thereto.

If the operating section 18 of the user terminal 10 is operated to put the pointer on the line connecting the icons, information of the keyword and the information of date and time included in the personal connection information will be displayed in a pop-up window as shown in FIG. 17. Here, in the data table shown in FIG. 15, since the personal connection information of the personal connection ID “1” and the personal connection information of the personal connection ID “4” have been registered as the personal connection information related to “Taro Yamada” of the person ID “1” and “Ken Sasaki” of the person ID “2”, the keyword and date and time included in the personal connection information of the personal connection ID “1” and the personal connection information of the personal connection ID “4” will be displayed in the pop-up window.

Incidentally, the display mode of the personal connection chart can be properly changed. For example, the line connecting two icons may also be provided for each piece of personal connection information. In other words, in the aforesaid case, the icon assigned to “Taro Yamada” and the icon assigned to “Ken Sasaki” may also be connected by two lines. Further, the line connecting two icons may also be displayed in different thickness according to the number of the pieces of personal connection information between the two icons. Further, the line connecting two icons may also be displayed in different color and/or shape (e.g., dotted line, dashed-dotted line, dashed-two dotted line or the like) according to the type (i.e., meeting minutes, contract, E-mail) included in the personal connection information.

According to the aforesaid embodiments, even if the personal name described in the data received by the personal connection information creating server 20 is not a full name, it is possible to identify the person indicated in the information extracted from the received data as the person indicated in the person information registered in the person information database 25a.

Further, it is possible to identify the person indicated by the name extracted from the received data as the person related to the personal connection information based on the personal connection information of the personal connection database. In other words, even if the received data only indicates a part of the information of a person, it is possible to identify such person.

Further, it is possible to identify persons indicated by the personal name extracted from the received data to thereby create a piece of personal connection information that indicates personal connection between the persons indicated by the personal name extracted from the received data.

Further, it is possible for the personal connection information creating server 20 to create a piece of personal connection information including keyword, date and time and the like described in the received data, and provide a personal connection chart capable of showing these items to the user terminal 10. Thus, it is also possible to grasp information, such as “when the persons met each other” and “what the persons talked about”, from the personal connection chart provided by the personal connection information creating server 20. Thus, it is possible to find a suitable person when the user wants to contact a person having know-how about how to promote a new project or wants to contact another company.

It is to be understood that the present invention is not limited to the aforesaid embodiments, and various application and modifications can be made without departing from the spirit and scope of the present invention described in the claims.

Further, it is to be understood that the aforesaid embodiments are examples for describing the construction of the device and system in a detailed and concrete manner so that the present invention can be better understood; however, the aforesaid configurations do not have to be fully included. Further, configurations of one embodiment can be partly substituted with configurations of other embodiments. Further, configurations of one embodiment can be added with a configuration(s) of other embodiments. Further, configurations of one embodiment can be partly omitted, or added with other configuration(s), or substituted with other configurations.

For example, in the aforesaid embodiments, the person identifying section 28b of the personal connection information creating section 28 refers to the person information database 25a to compare the name in each piece of person information with the extracted name; and if the both exactly match each other, the name in the person information will be counted as “1”, and if the both partially match each other, the name in the person information will be counted as “0.5”. Further, the person identifying section 28b of the personal connection information creating section 28 compares the affiliation of each piece of person information with the extracted affiliation; if the both exactly match each other, the affiliation of the person information will be counted as “1”; and if the both partially match each other, the affiliation of the person information will be counted as “0.5”. However, the count values can be properly set, instead of being limited to the aforesaid values.

Further, it is also possible to change the count values for each item (i.e., it is also possible to apply different weighting to the count values for each item). To be specific, the weighting may be set so that, with regard to the item “name”, if the item “name” in the person information exactly matches the extracted name, the item “name” in the person information will be counted as “1”, and if the item “name” in the person information partially matches the extracted name, the item “name” in the person information will be counted as “0.5”; while, with regard to the item “affiliation”, if the item “affiliation” in the person information exactly matches the extracted affiliation, the item “affiliation” in the person information will be counted as “0.5”, and if the item “affiliation” in the person information partially matches the extracted affiliation, the item “affiliation” in the person information will be counted as “0.25”. In other words, the weighting applied to the item “name” is set to be twice as the weighting applied to the item “affiliation”.

Further, in the aforesaid embodiments, the person identifying section 28b of the personal connection information creating section 28 refers to the person information database 25a to compare the name and affiliation of each person information with the name and affiliation extracted from the received data, and if there is (are) matched item(s), the person identifying section 28b will perform count for such item(s). However, the items to be compared may be properly set. For example, it is also possible to compare the telephone number registered in the person information database 25a with the telephone number extracted from the received data. Further, in the case where an E-mail address is registered in the person information database 25a, it is also possible to compare the E-mail address registered in the person information database 25a with the E-mail address extracted from the received data. Similarly, when comparing each item extracted from the received data with each item of the personal connection information, the number and type of the items to be compared can be properly set.

Further, it has been described in the aforesaid embodiments that, as shown in FIG. 10, whether or not the total sum of the count of the person information related to the person having been selected as a pertinent candidate is equal to or larger than 1 determined, and if such total sum is less than 1, the processing from step S6 (i.e., processing for referring the personal connection database) will be performed. However, in addition to the above processing, processing for referring the personal connection database may be performed if a plurality of persons are selected as pertinent candidates in step S3.

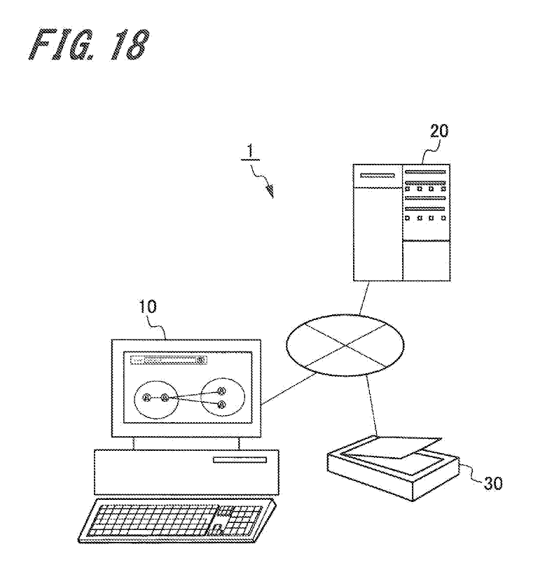

Further, one or more embodiments are described using an example in which a computer device such as a personal computer is used as the user terminal 10; however, a tablet terminal, a smartphone or the like may also be used as the user terminal 10. Further, as shown in FIG. 18, a scanner 30 for reading a document into image data and sending the image data to the personal connection information creating server 20 may also be used, and a MFP (Multi Functional Peripherals) having scanner function may also be used.

Further, in the specification of the present invention, the processing steps for describing time-series processing not only includes the processing performed in time series along with the described order, but also includes the processing that is not performed in time series but performed in parallel or individually (for example, parallel processing or processing by an object).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A personal connection information creating device comprising:
a first information source that stores a plurality of pieces of first information each having a plurality of items including a personal name; and
a personal connection information creator that creates personal connection information among persons based on a second information source,
wherein the personal connection information creator comprises:
an extractor that extracts second information from the second information source, the second information having a plurality of items including a personal name; and
a person identifier that compares the plurality of items of each of the plurality of pieces of first information stored in the first information source with the plurality of items of the second information, item by item, counts an exactly matched item, if any, as a first value and a partially matched item, if any, as a second value smaller than the first value, and identifies a person indicated in the first information having the maximum total sum of the count as the person in the second information source,
and
wherein the personal connection information creator creates the personal connection information related to the person identified by the person identifier.

2. The personal connection information creating device according to claim 1, wherein, with regard to the first information having the maximum total sum of the count, if the total sum is equal to or larger than a predetermined value, the person identifier identifies the person indicated in the first information as the person in the second information source.

3. The personal connection information creating device according to claim 1, wherein the person identifier applies predetermined weighting to the first value and the second value depending on each of the items to be compared.

4. The personal connection information creating device according to claim 2 further comprising:
a personal connection information storage that stores the personal connection information,
wherein the personal connection information creator creates the personal connection information including the second information, and stores the created personal connection information in the personal connection information storage, and
wherein, with regard to the first information having the maximum total sum of the count, if the total sum is smaller than the predetermined value, the person identifier compares the items of each piece of the personal connection information stored in the personal connection information storage with the items of the second information, item by item, counts an exactly matched item, if any, as the first value and a partially matched item, if any, as the second value, and identifies a person related to the personal connection information having the maximum total sum of the count as the person in the second information source.

5. The personal connection information creating device according to claim 1, wherein the second information source includes date and time information and contents of a meeting minutes, as the items.

6. The personal connection information creating device according to claim 1, wherein the first information source is a person information storage that stores a plurality of pieces of the first information each including a personal name and affiliation information that includes information about company and/or department with which the person of the personal name is affiliated.

7. A non-transitory recording medium storing a computer readable personal connection information creating program that causes a personal connection information creating device to operate, the personal connection information creating device comprising: a first information source that stores a plurality of pieces of first information each having a plurality of items including a personal name; and a personal connection information creator that creates personal connection information among persons based on a second information source,
wherein the personal connection information creating program causes the personal connection information creating device to execute:
extracting second information from the second information source, the second information having a plurality of items including a personal name;
comparing the plurality of items of each of the plurality of pieces of first information stored in the first information source with the plurality of items of the second information, item by item, counting an exactly matched item, if any, as a first value and a partially matched item, if any, as a second value smaller than the first value, and identifying a person indicated in the first information having the maximum total sum of the count as the person in the second information source; and
creating the personal connection information related to the identified person.

8. The non-transitory recording medium according to claim 7, wherein, with regard to the first information having the maximum total sum of the count, if the total sum is equal to or larger than a predetermined value, the comparing includes identifying the person indicated in the first information as the person in the second information source.

9. The non-transitory recording medium according to claim 7, wherein the comparing applies predetermined weighting to the first value and the second value depending on each of the items to be compared.

10. The non-transitory recording medium according to claim 9,
wherein the personal connection information creating device further comprises a personal connection information storage that stores the personal connection information,
wherein the creating includes creating the personal connection information including the second information, and storing the created personal connection information in the personal connection information storage, and
wherein, with regard to the first information having the maximum total sum of the count, if the total sum is smaller than the predetermined value, the comparing includes comparing the items of each piece of the personal connection information stored in the personal connection information storage with the items of the second information, item by item, counting an exactly matched item, if any, as the first value and a partially matched item, if any, as the second value, and identifying a person related to the personal connection information having the maximum total sum of the count as the person in the second information source.

11. The non-transitory recording medium according to claim 7, wherein the second information source includes date and time information and contents of a meeting minutes, as the items.

12. The non-transitory recording medium according to claim 7, wherein the first information source is a person information storage that stores a plurality of pieces of the first information each including a personal name and affiliation information that includes information about company and/or department with which the person of the personal name is affiliated.

13. A personal connection information creating method in a personal connection information creating system comprising: a first information source that stores a plurality of pieces of first information each having a plurality of items including a personal name; and a personal connection information creator that creates personal connection information among persons based on a second information source, the method comprising:
extracting second information from the second information source, the second information having a plurality of items including a personal name;
comparing the plurality of items of each of the plurality of pieces of first information stored in the first information source with the plurality of items of the second information, item by item, counting an exactly matched item, if any, as a first value and a partially matched item, if any, as a second value smaller than the first value, and identifying a person indicated in the first information having the maximum total sum of the count as the person in the second information source; and
creating the personal connection information related to the identified person.

14. The personal connection information creating method according to claim 13, wherein, with regard to the first information having the maximum total sum of the count, if the total sum is equal to or larger than a predetermined value, the comparing includes identifying the person indicated in the first information as the person in the second information source.

15. The personal connection information creating method according to claim 13, wherein the comparing applies predetermined weighting to the first value and the second value depending on each of the items to be compared.

16. The personal connection information creating method according to claim 15,
wherein the personal connection information creating device further comprises a personal connection information storage that stores the personal connection information,
wherein the creating includes creating the personal connection information including the second information, and storing the created personal connection information in the personal connection information storage, and
wherein, with regard to the first information having the maximum total sum of the count, if the total sum is smaller than the predetermined value, the comparing includes comparing the items of each piece of the personal connection information stored in the personal connection information storage with the items of the second information, item by item, counting an exactly matched item, if any, as the first value and a partially matched item, if any, as the second value, and identifying a person related to the personal connection information having the maximum total sum of the count as the person in the second information source.

17. The personal connection information creating method according to claim 13, wherein the second information source includes date and time information and contents of a meeting minutes, as the items.

18. The personal connection information creating method according to claim 13, wherein the first information source is a person information storage that stores a plurality of pieces of the first information each including a personal name and affiliation information that includes information about company and/or department with which the person of the personal name is affiliated.
